(19) United States
(12) Patent Application Publication
(10) Pub. No.: US 2010/0165606 A1
(43) Pub. Date: Jul. 1, 2010

(54) IMPROVEMENTS IN OR RELATING TO WALLS

(75) Inventor: John Paterson, Strathclyde (GB)

Correspondence Address: HESLIN ROTHENBERG FARLEY & MESITI PC, 5 COLUMBIA CIRCLE, ALBANY, NY, 12203, US

(73) Assignee: Westcrowns Contracting Services Limited, Glasgow, Strathclyde (GB)

(21) Appl. No.: 12/278,793

(22) PCT Filed: Feb. 7, 2007
(86) PCT No.: PCT/GB07/50052

§ 371 Date: Aug. 8, 2008

(30) Foreign Application Priority Data
Feb. 10, 2006 (GB) 0602679.3

(51) Int. Cl. F21S 8/00; E04F 19/02

(52) U.S. Cl. 362/147; 52/173.1; 52/28

(57) ABSTRACT

A glass or plastic wall structure with nested channel members is provided with electroluminescent strips running along the channel flanges to provide an internal illumination. In particular, it relates to illuminated transparent walls or internal partitions of a building or similar fixed construction.

The present invention relates to improvements in or relating to walls, in particular to illuminated transparent or translucent walls.

A “wall” in this context is taken to mean a wall of a building or similar fixed construction, either internal or external. The term also encompasses internal partitions for a building, which may extend only part way between the floor and ceiling of a room in a building.

There are a number of different construction materials available for the formation of a building's walls. One material, which can be chosen, is glass. Its light transmission properties can create a spacious light and airy aspect within a building.

Because of the transparency of glass, it is known to provide illumination to further improve the appearance of a building or to increase its visibility. However, this requires the installation of separate illumination apparatus, which must be separately installed and powered and arranged close to the wall.

According to a first aspect of the present invention there is provided a transparent or translucent wall comprising internal illumination means.

According to a second aspect of the invention there is provided a transparent or translucent wall component that comprises illumination means.

Preferably, the wall is formed from a glass or plastic material.

Preferably, the wall comprises a plurality of nested channel members.

Preferably, the illumination means is provided at a side flange of at least one channel member.

Preferably, the illumination means comprises an electroluminescent strip.

Preferably, the electroluminescent strip is adhesively bonded to the channel flange.

Preferably, the electroluminescent strip has a split electrode structure.

Alternatively, the electroluminescent strip has a parallel electrode structure.

Preferably, the illumination means comprises one or more light emitting diodes (LED's).

Preferably, a DC-AC inverter is provided to power the illumination means.

Preferably, the wall comprises an upper housing member and a lower housing member for receiving the channel members.

Preferably, the upper and/or lower housing members comprises power connection means for the illumination means.

Preferably, a frame member is provided for housing the upper and lower housing members and the wall structure.

According to a third aspect of the invention there is provided a building comprising a wall structure according to the first aspect.

The present invention will now be described, by way of example only, with reference to the accompanying drawings, in which:

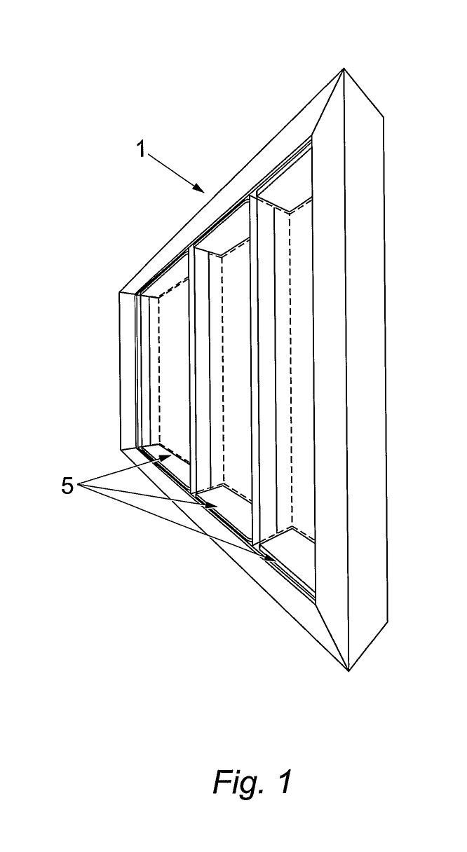

FIG. 1 shows an exploded view of a wall according to the first embodiment of the invention;

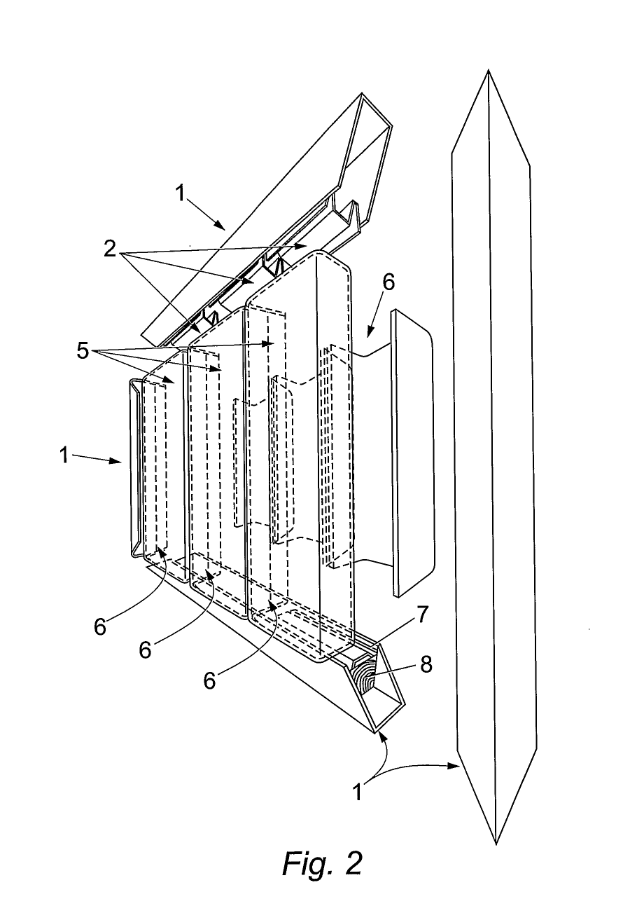

FIG. 2 shows an exploded view of how the wall of FIG. 1 is assembled to include the illumination mean; and

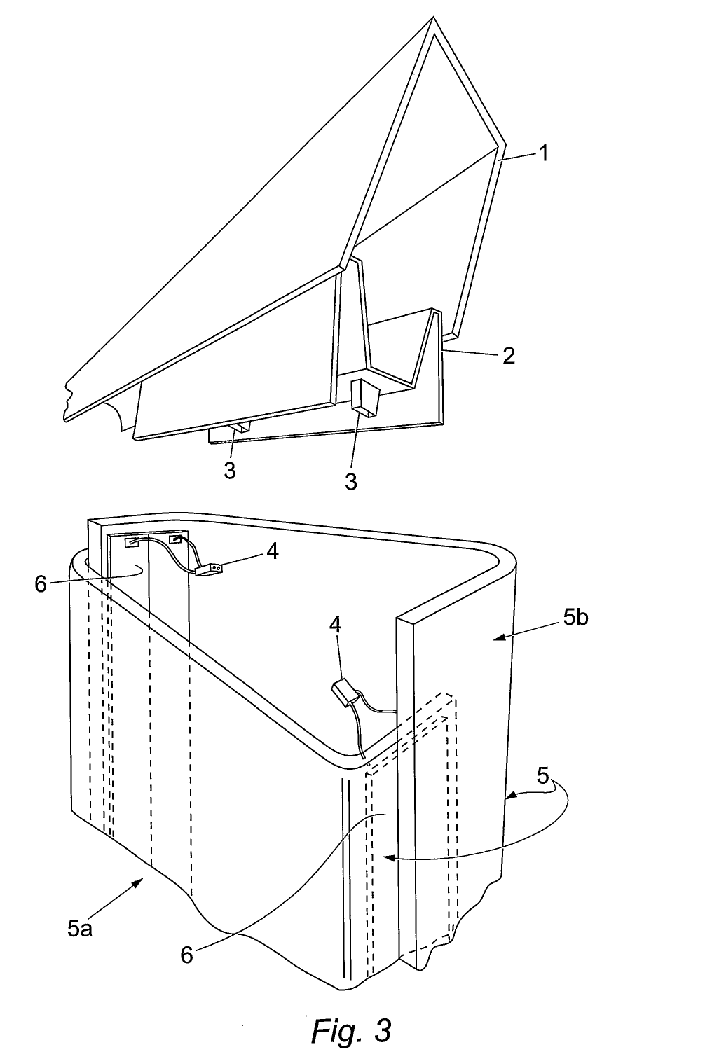

FIG. 3 shows the arrangement of the first embodiment; and

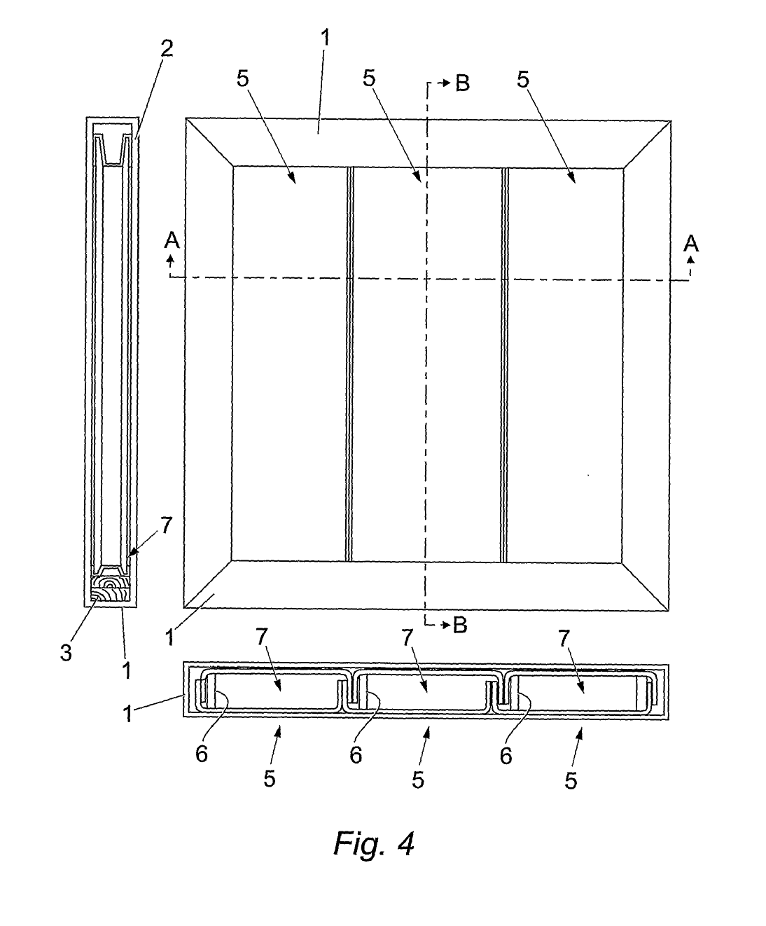

FIG. 4 shows an orthographic view of the wall in FIG. 1 containing a sectional view showing the means of illumination.

One particular type of currently available profiled glass wall system is the U channel glass wall system. Within this system, translucent cast glass U channels are fitted into an extruded metal perimeter frame and are fixed in place by the use of a silicone sealant.

The channels can be installed either vertically or horizontally and are supplied in a variety of colours and textures with varying translucency. The system can be single glazed or dual glazed, and can be used to form walls of any chosen profile or curvature.

In the first embodiment of the present invention a wall structure comprises a plurality of interlocking channel members and an electroluminescent strip is provided along the edges of the channels. FIG. 1 shows a specific implementation of this embodiment with a profiled glass wall system, specifically, the U-channel system previously identified. A number of panels (5) are enclosed within the frame (1).

An exploded view is shown in FIG. 2. The glass wall system comprises a plurality of panels (5), which are formed in a nested channel formation, and an electroluminescent strip (6) is provided at the sides of the channels. The pieces (5) are held between a lower plastic insert (7) and a top plastic insert (2) which comprises holes for housing the power connectors (3) for the electroluminescent strip (6). A packing material (8) and frame (1) completes the system.

As seen in FIG. 2, a plurality of outward facing channels (with flanges pointing into the page) are placed side-by-side, with a plurality of inward facing channels (with flanges pointing out of the page) providing a nested interlock.

FIG. 3 shows the incorporation of the electroluminescent strips (6) on the channels (5). An outward facing channel (5a) has an electroluminescent strip (6) adhesively bonded to the inner edge of its right hand flange, while the inward facing channel (5b) has an electroluminescent strip (6) adhesively bonded to the inner edge of its left hand flange. Thus, the space enclosed by the two interlocked channels (5) is directly illuminated by the electroluminescent strips (6).

Female power connectors (3) are provided on a flange of the top plastic insert (2) for connection with the male power connectors (4) at the top of each electroluminescent strip (6).

In one embodiment a single strip is provided which has connectors in another embodiment each vertical channel has a connector provided at the top of each strip (6) provided thereon. A wiring loom (not shown) is provided which runs through the frame (1), for providing power to the electroluminescent strip (6) by means of an Inverter (not Shown).

The scope of the invention is not limited to any particular type of illumination. However, the use of an electroluminescent strip is advantageous. An incandescent lamp or a tungsten lamp has a very low energy efficiency—approximately 85% of the energy is given off as heat, and they also have a short lifetime—approximately 1000 hours. Halogen bulbs are an improvement but still provide relatively high heat losses and have a relatively short lifetime.

Fluorescent lamps are 4 to 5 times more efficient than tungsten lamps and have an improved lifetime of up to 10,000 hours. However, for the current application the required area of the electrodes combined with the transformer used to run the lamps is excessively large does not make them an attractive option, and there are also environmental issues to do with safe disposal of the mercury used in the lamps.

Light emitting diodes (LED's) have a long lifetime and low power requirement, but because they act as point sources of light, generating a specific light pattern that is not always desirable.

An electroluminescent light, also known as a light emitting capacitor (LEC) produces light when phosphor crystals are excited by being exposed to an AC electric current. Electroluminescent panels and strips can be found as back lighting for LCD's in pagers, cell phones, watches and control panels as well as strip lighting for egress decor architecture, broadcast sets and others.

Because no filament is included, the strips have a very long life, are flexible, cool to the touch and highly visible in darkness, smoke and fog etc. The strips also have a very low energy consumption, contain few hazardous materials and require no maintenance.

Electroluminescent film is powered either by parallel electrodes or split electrodes. An electroluminescent lamp comprises a phosphor layer interposed between a clear conductive ITO layer and a rear electrode. In a parallel plate electroluminescent lamp, voltage is applied between the top ITO layer and the rear electrode whereas in a split electroluminescent lamp, a split is made in the rear electrode and a voltage is applied across the two created sides of the electrode.

A power inverter is provided to convert DC power or direct current to standard AC power or alternating current. A compensating inverter can maximise a lamp life by maintaining a variable output as the lamp goes through the normal ageing process.

Other power sources can also be used with a limiting resistor to step down the power of a transformer to step it up as in the case of using a low power amplifier.

Electroluminescent film comes in ten basic colours but some colours will vary depending on the frequency used to power them. Another method of colouring the lamps are by the use of gels, these are simply coloured plastic films. Different colours can be spliced together with wire cutters.

Since in the present embodiment the film runs on a parallel circuit it only needs to be properly terminated when trimmed This can be accomplished by using super glue, epoxy or other types of sealers to protect the film from moisture. After a period of time the electroluminescent film will become dimmer This happens more quickly when powered by a higher voltage and or frequency.

The wall structure of the present invention can incorporate other features of known glass walls to give specific optical characteristics such as a different opacities for different light transmission level or different diffuseness of light, acoustic properties giving sound insulation up to appropriate levels or thermal insulation for example giving double glazing or having special coatings on the glass, such as hard pyrolytic surface coatings. The pyrolytic coating creates a very slight coat sheen coat to the glass but does not affect the intrinsic colour of the glass channels. Also, specialised glass types with a solar control coating to reduce the amount of solar energy transmitted through the glazing can be provided.

Connections to the electroluminescent lamp can be flexible printed circuits solderable metal strip, contact pads, solder pads, or other customised designs according to a customer's individual requirements.

The inverter can also be linked to a control means to provide special animation effects for the light—cycling the colour, pattern and timing of various strips.

The glass panels can be used for a number of different installation techniques such as vertical and horizontal glazing (single or double) curved glazing, glass corners, wind tankers, horizontal glazing, roof glazing and window casements.

Due to its flat profile, the electroluminescent film can be incorporated into existing profiled glass systems without interfering with the existing structure. All that is required is a slight modification to the upper plastic inserts to incorporate wiring connectors for a wiring loom; the addition of protection grommets attached to the aluminium frame to protect the power cable; and a mounting frame for the inverter.

Thus the present invention provides for the creation of distinctive light effects which can be enhanced by using sand blasted glass giving a near constant wash of light across the glass systems' compartments. It is also possible to use a clear glass structure to highlight the internal structure.

The invention is not limited to the described embodiment. The limitations of the invention are set out in the attached claims. Various improvements and embodiments can be made to the above without the parting from the scope of the invention.

1. A transparent or translucent wall comprising an internal illumination means.

2. The wall of claim 1, formed from a glass or plastic material.

3. The wall of claim 1, comprising a plurality of nested channel members.

4. The wall of claim 3, wherein the illumination means is provided at a side flange of at least one channel member.

5. The wall of claim 1, wherein the illumination means comprises one or more light emitting diodes.

6. The wall of claim 1, wherein the illumination means comprises an electroluminescent strip.

7. The wall of claim 6, wherein the electroluminescent strip is adhesively bonded to a channel flange.

8. The wall of claim 6, wherein the electroluminescent strip has a split electrode structure.

9. The wall of claim 6, wherein the electroluminescent strip has a parallel electrode structure.

10. The wall of claim 1, wherein a DC-AC inverter is provided to power the illumination means.

11. The wall of claim 3, further comprising an upper housing member and a lower housing member for receiving the plurality of nested channel members.

12. The wall of claim 11, wherein the upper and/or lower housing member comprises a power connection means for the illumination means.

13. The wall of claim 11, further comprising a frame member for housing the upper and lower housing members and a wall structure.

14. A transparent or translucent wall component comprising an illumination means.

15. The wall component of claim 14, wherein the wall component is fabricated from a glass or plastic material.

16. The wall component of claim 14, wherein the wall component is formed as a channel.

17. The wall component of claim 16, wherein the illumination means is provided at one or both side flanges of the channel.

18. The wall component of claim 14, wherein the illumination means comprises one or more light emitting diodes.

19. The wall component of claim 14, wherein the illumination means comprises an electroluminescent strip.

20. The wall component of claim 19, wherein the electroluminescent strip is adhesively bonded to a channel flange.

21. The wall component of claim 19, wherein the electroluminescent strip has a split electrode structure.

22. The wall component of claim 19, wherein the electroluminescent strip has a parallel electrode structure.

23. A building comprising a wall, wherein the wall comprises an internal illumination means.

24. A building comprising a wall component, wherein the wall component comprises an illumination means.
